(19) United States
(12) Patent Application Publication
(10) Pub. No.: US 2003/0056587 A1
(43) Pub. Date: Mar. 27, 2003

(54) Thermochromatic indicator for an aersol container

(76) Inventors: M. Scott Carpenter, Racine, WI (US); William I. Archer, Racine, WI (US)

Correspondence Address: S.C. JOHNSON & SON, INC., 1525 HOWE STREET, RACINE, WI, 53403-2236, US

(21) Appl. No.: 09/955,756

(22) Filed: Sep. 19, 2001

(51) Int. Cl. G01F 23/00; G01D 21/00

(52) U.S. Cl. 73/290 R; 116/206; 116/227

(57) ABSTRACT

An aerosol container includes an aerosol canister for containing a flowable product at a pressure greater than ambient pressure, a dispensing valve for dispensing the flowable product from the aerosol canister, and a thermochromatic indicator provided on the aerosol canister. The thermochromatic indicator preferably is comprised of one or more thermochromatic materials and can provide a visual indication of at least one of (i) a fill level of the flowable product in the aerosol container and (ii) whether the temperature of the aerosol container in the vicinity of the thermochromatic indicator exceeds a predetermined temperature. Also disclosed are methods of detecting a fill level of a flowable product in an aerosol container using a thermchromatic indicator and manufacturing an aerosol container having a thermochromatic indicator. A thermochromatic pattern can also be applied to an aerosol container for a decorative effect.

### BACKGROUND OF THE INVENTION

1. Field of the Invention

This invention relates generally to a device for indicating the state of an aerosol container and its contents, and, in particular, to a thermochromatic indicator for indicating the fill level of an aerosol container and/or whether the temperature of the container exceeds a predetermined temperature. This invention also relates to a method of manufacturing an aerosol container having a thermochromatic indicator and a method of using a thermochromatic indicator to detect the state of an aerosol container and its contents.

2. Description of the Related Art

Thermochromatic materials are well known, and their use to provide an external, visual indication of the fill level of a container, usually a propane tank or the like, has been the subject of numerous patents dating back to at least the early 1970s.

For example, U.S. Pat. No. 3,696,675 discloses a liquid level gauge for externally measuring the level of a liquid or flowable granular material in a container. The gauge is an elongated strip of material coated or imbedded with a thermochromatic substance, such as a cholesteric liquid crystal compound, which varies chromatically with variations in temperature. The gauge is secured to the outer surface of the container, in heat conducting relationship thereto, using a pressure sensitive adhesive, for example. When the container is exposed to an external temperature change, due to the difference in the rate of heat conduction between the filled space and the void volume of the container, the container wall experiences a temperature gradient that is most pronounced at the interface of the filled space and the void volume. An abrupt change in color of the elongated strip appears where the temperature gradient is greatest, thereby allowing an observer to detect the fill level of the container. The '675 patent states that the level gauge described therein can be used to monitor the level of liquid fuel in a pressurized container, such as a propane tank, or, alternatively, the gauge can be used in connection with motor vehicle radiators, oil immersed transformers, circuit breakers, tank type oil immersed capacitor stacks, coffee urns, or grain storage installations.

U.S. Pat. No. 4,358,955 purportedly improves upon the level gauge of the '675 patent. Specifically, the '955 patent asserts that adhesively securing the gauge to the container, as disclosed in the '675 patent, does not permit the gauge to be readily removed and replaced for use on different containers or at different locations on the same container, and, furthermore, impedes heat conduction between the container wall and the thermochromatic material. The '955 patent proposes a level gauge having a magnetized base layer that enables the gauge to be repeatedly attached to and removed from a container made of a magnetic material. The '955 patent further asserts that the magnetized base layer improves heat conduction between the container wall and the thermochromatic material of the gauge. Included among the applications for the level gauge disclosed in the '955 patent are liquid gas fuel tanks (e.g., liquid propane tanks), oil immersed electrical equipment (e.g., transformers, capacitators, circuit breakers), and motor vehicle radiators.

Similarly, U.S. Pat. No. 5,323,652 discloses a transportable thermochromic level indicator for a propane tank. The indicator includes two or more thermochromic materials having different opacities and transition temperatures. The thermochromic material with the greater opacity has a relatively lower transition temperature than the thermochromic material with the lesser opacity. The '652 patent asserts that the use of two or more thermochromic materials helps a user distinguish between variations in color by producing identifiable chromatic changes over time after heat is applied. The use of more than one thermochromic material also is said to provide versatility for operation in different ambient temperatures.

Despite the widespread use of thermochromatic indicators for propane tanks and the like, as far as the inventors are aware, such indicators have not previously been used for detecting the fill level of aerosol containers. Common household and commercial aerosol products include cleaning products, air fresheners, furniture polish, insect repellants, disinfectants, and the like. Conventionally, a user would have to guess how much of an aerosol product was left by shaking the container. This, of course, is an inexact method, and oftentimes leads to running out of the product unexpectedly before a replacement can be purchased.

A further problem with conventional aerosol containers is that they do not have any means for warning users if the temperature of the container reaches an unsafe level. Exposure to high temperatures can cause the internal pressure of the container to reach a dangerous level, which can lead to rupturing of the container and potentially severe injury to a user.

Accordingly, there is a need in the art for a better, more accurate way to determine the amount of a product left in an aerosol container.

There also is a need in the art for a way to warn a user of an aerosol container if the temperature of the container reaches an unsafe level.

### SUMMARY OF THE INVENTION

The present invention addresses the foregoing needs in the art by providing a thermochromatic indicator for an aerosol container.

Although thermochromatic indicators for propane tanks and the like have been around for at least thirty years, and aerosol containers for even longer, there has remained a long-felt but unresolved need in the art for a reliable means for providing a visual indication of the state of an aerosol container and its contents. One reason for this, the inventors suspect, is that prior art thermochromatic indicators have been specifically designed for use on reusable containers, or else have been designed so as to be easily transferable from one container to another, such as when exchanging an empty propane tank for a full one. Aerosol containers, by contrast, generally are single-use containers which are discarded after their contents are emptied. Prior to the present invention, it is believed that no one had successfully designed an economical and reliable thermochromatic indicator for an aerosol container.

According to one aspect of the invention, an aerosol container includes an aerosol canister for containing a flowable product at a pressure greater than ambient pressure, a dispensing valve for dispensing the flowable product from the aerosol canister, and a thermochromatic indicator provided on the aerosol canister for providing a visual indication of a state of the container. In one embodiment, the thermochromatic indicator provides a visual indication of a fill level of the flowable product in the aerosol canister. In another embodiment, the thermochromatic indicator provides a visual warning if the temperature of the aerosol canister in the vicinity of the thermochromatic indicator exceeds a predetermined temperature.

In another aspect, this present invention relates to an aerosol product including a pressurizable aerosol container, a flowable product contained within the aerosol container, and a thermochromatic indicator. The aerosol container includes a dispensing valve and an actuator for selectively opening the dispensing valve. The thermochromatic indicator provides a visual indication of at least one of (i) a fill level of the flowable product in the aerosol container and (ii) whether the temperature of the aerosol container in the vicinity of the thermochromatic indicator exceeds a predetermined temperature.

In still another aspect, this invention relates to an aerosol container including an aerosol canister for containing a flowable product at a pressure greater than ambient pressure, means for dispensing the flowable product from the aerosol canister, and means for providing a visual indication of at least one of (i) a fill level of the flowable product in the aerosol canister and (ii) whether the temperature of the aerosol canister exceeds a predetermined temperature.

In a further aspect, this invention relates to a method of detecting a fill level of a flowable product in an aerosol container, including the steps of inducing a temperature differential in the vicinity of a thermochromatic indicator provided on a wall of the aerosol container, and detecting, based on a change in appearance of the thermochromatic indicator, the fill level of the flowable product in the aerosol container.

In a still further aspect, this invention relates to a method of manufacturing an aerosol container having a thermochromatic indicator or pattern, including the steps of fabricating an aerosol container, and providing a thermochromatic indicator or pattern on the aerosol container and in heat-conducting relationship to a wall of the aerosol container.

In another aspect, this invention relates to an aerosol container including an aerosol canister for containing a flowable product at a pressure greater than ambient pressure, a dispensing valve for dispensing the flowable product from the aerosol container, and a thermochromatic pattern provided on the aerosol canister.

A better understanding of these and other objects, features, and advantages of the invention may be had by reference to the drawings and to the accompanying description, in which preferred embodiments of the invention are illustrated and described.

### BRIEF DESCRIPTION OF THE DRAWINGS

FIG. 1 is partial cut-away, front elevational view of one embodiment of an aerosol container according to the present invention.

FIG. 2 is a front elevational view of another embodiment of an aerosol container according to the present invention.

FIG. 3 is a front elevational view of still another embodiment of an aerosol container according to the present invention.

FIG. 4 is a front elevational view of yet another embodiment of an aerosol container according to the present invention.

FIG. 5 is a partial cut-away, front elevational view of an aerosol container according to the present invention while sitting at rest.

FIG. 6 is a partial cut-away, front elevational view of the aerosol container shown in FIG. 5 shortly after dispensing product from the container.

Throughout the figures, like reference numerals have been used for like or corresponding parts.

### DESCRIPTION OF THE PREFERRED EMBODIMENTS

The thermochromatic indicator of the present invention is intended for use with an aerosol container capable of dispensing a flowable product. The indicator detects the state of the container and its contents, including, for example, the fill level of the flowable product in the container and whether the temperature of the container exceeds a predetermined temperature. The indicator further provides a visual indication regarding the state of the container and its contents. The container may also include a thermochromatic pattern for a unique decorative effect.

The term “flowable product,” as used herein, broadly includes any liquid, semiliquid, or flowable granular material capable of being dispensed from an aerosol container. Examples of liquids and flowable granular materials encompassed by the term “flowable product” include cleaning products, air fresheners, insect repellants, furniture polish, floor care products, disinfectant sprays, shaving creams, sprayable cooking oils, carpet cleaners, sprayable deodorants, and the like.

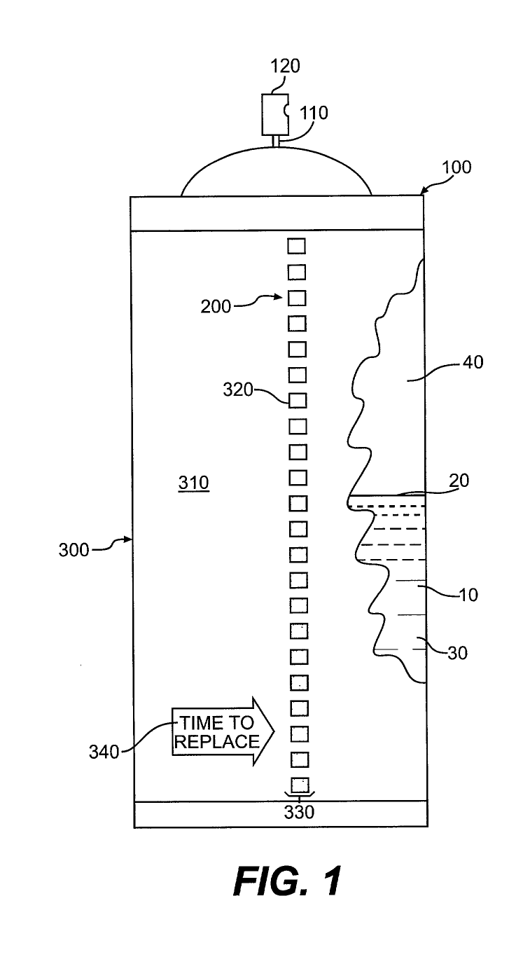

FIG. 1 shows an aerosol container 100. The container 100 is a pressurizable canister capable of withstanding internal pressures above ambient air pressure. The container 100 has a dispensing valve 110 and an actuator 120 for dispensing the flowable product 10 from the container 100. Aerosol containers themselves are well known in the art, and, therefore, will not be discussed in detail herein.

The aerosol container 100 can have virtually any shape. Preferably, the aerosol container 100 is made of steel or aluminum. Other materials, however, may be suitably employed for the container 100, including, for example, metals, alloys, glass, polymers, and other barrier materials.

The aerosol container 100 shown in FIG. 1 is one that can be easily held in a user's hand while the user presses the actuator 120 to dispense the flowable product 10. In another embodiment, the aerosol container can be attached to a secondary device (not shown) having either a manual or automatic actuator. For example, the aerosol container can be designed for use in conjunction with an air freshening device having an automatic time-release actuator.

The aerosol container 100 can be filled with a flowable product 10 and then pressurized, or, alternatively, a flowable product 10 can be mixed under pressure with a pressurized gas or liquid propellant.

One example of a thermochromatic indicator 200 is shown in FIG. 1. In this embodiment, the thermochromatic indicator 200 is provided in the form of a label 300, such as a wrap-around label, a peelable spot label, a spot label, a seemed shrink sleeve, a wrap-around shrink label, a stretch label, or the like. The label 300 is applied in tight registration with the container 100.

The label 300 preferably comprises a paper or polymer-based substrate 310 that is coated or embedded, wholly or in part, with one or more thermochromatic materials 320. The thermochromatic material 320 can be conventionally applied to the substrate 310 by painting, striping, screen printing, or any other suitable coating or embedding method. The thermochromatic material 320 can be applied to the surface of the substrate 310 that faces away from the container 100, or, if the substrate is clear or translucent, the thermochromatic material 320 can be applied to the surface of the substrate 310 that faces toward the container 100. In the latter case, the substrate 310 preferably possesses properties that reduce or prevent the transmission of ultraviolet light to the thermochromatic material 320, thereby prolonging the effective life of such material. Ultraviolet inhibitor additives and lacquers for achieving this purpose are well known in the art.

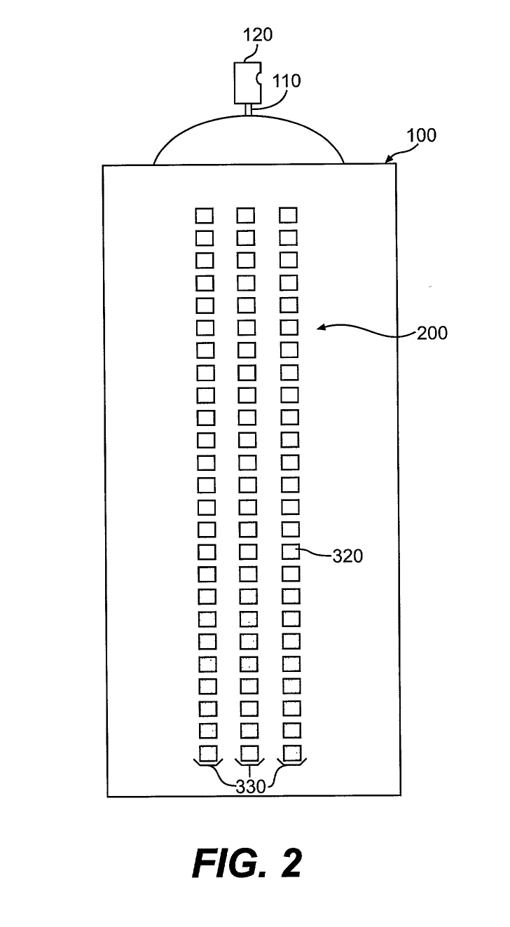

In another embodiment, shown in FIG. 2, the thermochromatic indicator 200 can be formed directly on the aerosol container 100. That is, one or more thermochromatic materials 320 can be printed on the sheet metal from which the container 100 is potentially fabricated, or else the thermochromatic material 320 can be printed on the finished container itself.

As used herein, the term “thermochromatic material” includes substances that undergo a visually apparent transformation when they cross a defined transition temperature. For example, the material may change from one color to another, from opaque to clear, from clear to opaque, etc. Preferably, but not necessarily, the transformation is reversible.

The thermochromatic material can be, for example, a cholesteric liquid crystal compound, a chiral nematic liquid crystal compound, a leuco dye, or any other thermochromatic material that is responsive in a desired temperature range. The thermochromatic material can be in the form of an ink, a dye, or any other suitable type of carrier. In some instances, it may be desirable to apply the thermochromatic material in microencapsulated form.

The color of a cholesteric liquid crystal compound, for example, changes as the temperature of the compound fluctuates back and forth through a range of temperatures referred to as the “mesophase range” or “color-play window.” Cholesteric liquid crystal compounds exhibit vivid color changes with slight changes in temperature (as small as 0.2° F.) over a wide range of temperatures (from about −25° F. to about +250° F.). Typically, a cholesteric liquid crystal compound appears clear at temperatures below the color-play window, then sequentially turns brown, red, yellow, green, blue, and violet as the temperature rises through the color-play window, before turning clear again at temperatures above the color-play window.

In the embodiments shown in FIGS. 1-3, the thermochromatic indicator 200 is used to detect a fill level 20 of the flowable product 10 within the container 100. The thermochromatic indicator can be formed as a vertical column 330 of a single thermochromatic material 320, as shown in FIG. 1, or, preferably, as a plurality of vertical columns 330 of different thermochromatic materials 320, each having a different color-play window, such as shown in FIG. 2.

The thermochromatic indicators 200 shown in FIGS. 1 and 2 work by sensing a temperature differential in the wall of the container 100. This temperature differential can be induced in any number of ways. For example, the aerosol container 100 can be exposed to heat from an external source (not shown), such as by dousing the portion of the container 100 in the vicinity of the indicator 200 with water or another liquid having a temperature greater than that of the container 100. Cooling the aerosol container 100 similarly will produce a temperature differential in the wall of the container 100. Due to the difference in the rates of heat conduction in the filled volume 30 and the empty volume 40 of the container 100, the container wall will experience a temperature differential that is most pronounced at the fill level 20 of the flowable product 10. The thermochromatic material 320 reacts to provide a visible color change indicative of the fill level 20.

The act of dispensing the flowable product 10 from the aerosol container 100 also can create a temperature differential in the container wall. In this case, when the product 10 is dispensed, the gaseous headspace (i.e., empty volume 40) above the flowable product 10 self-cools as a result of the heat of vaporization. The resulting temperature difference between the filled volume 30 and the empty volume 40 creates a temperature differential in the container wall that is most pronounced at the fill level 20 of the flowable product 10. The thermochromatic material 320 thus reacts to provide a visible color change indicative of the fill level 20.

Optionally, a time-to-replace indicator 340, such as shown in FIG. 1, may be provided in conjunction with the fill level indicator 200.

Preferably, the thermochromatic material 320 is a liquid crystal compound with a color-play window of approximately 2° F. The thermochromatic material 320 should be selected so that it is responsive within the temperature range in which the aerosol container normally is stored and used (e.g., room temperature). The use of a plurality of thermochromatic materials, each with a color-play window spanning a different temperature range, permits the indicator to be used in a wider range of ambient conditions than if a single thermochromatic material is used.

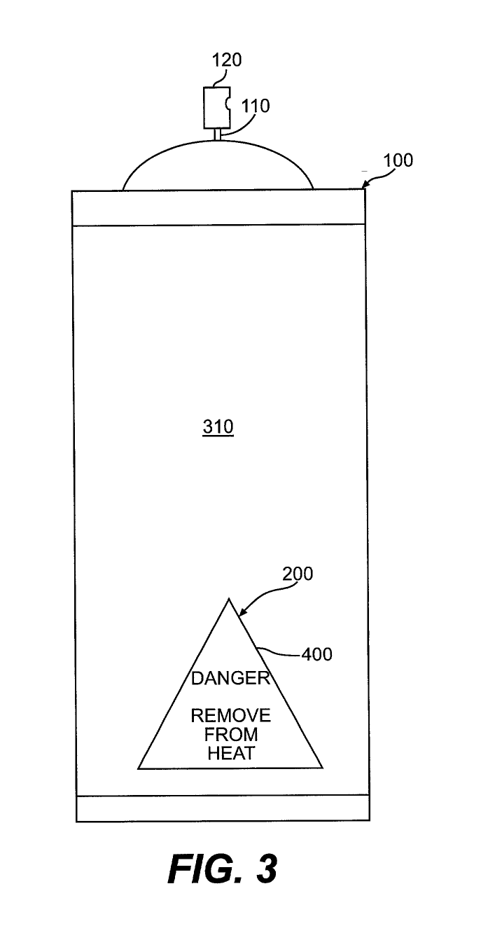

In another embodiment, shown in FIG. 3, the thermochromatic indicator 200 can be used to provide a visual warning 400 when the aerosol container 100 and its contents reach a predetermined temperature. The predetermined temperature will vary from container to container, depending on the ability of the particular container to withstand elevated temperatures and the associated increases in internal pressure. This feature can help prevent rupturing of the container and also can help avoid potentially severe injury to a user. For example, the warning 400 can be printed on a label 300 or on the container 100 itself using a liquid crystal compound that appears clear or translucent below the predetermined temperature and which changes to a color at the predetermined temperature. Thus, when the predetermined temperature is reached, the warning 400 appears. Preferably, the color-play window for the liquid crystal compound is sufficiently wide (e.g., from about 130° F. to about 250° F.) so that a further increase in temperature does not cause the warning 400 to disappear even though a danger still exists. As shown in FIG. 3, the warning 400 can comprise, for example, a brightly-colored triangle containing the words “DANGER REMOVE FROM HEAT” or the like.

Alternatively, the warning 400 can be printed on a label 300 or directly on the container 100 and then covered with a clearing ink containing a thermochromatic material. Preferably, the clearing ink is normally black (or another opaque color) and changes to clear when heated above the predetermined temperature. Thus, when the container reaches the predetermined temperature, the clearing ink becomes visually transparent and the warning 400 can be observed.

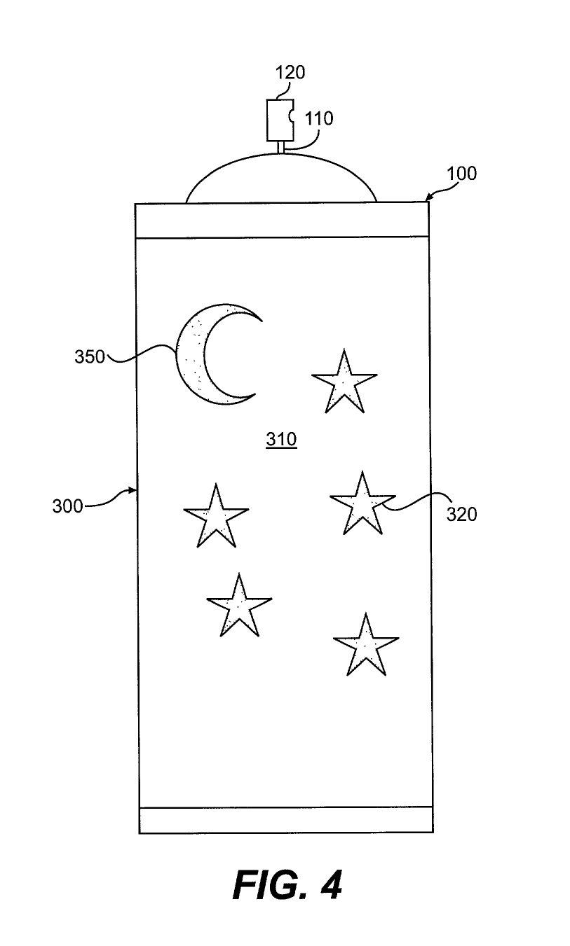

In still another embodiment, shown in FIG. 4, a thermochromatic material can be applied to an aerosol container for a decorative effect. In FIG. 4, a decorative thermochromatic pattern 350 is formed on a label 300 using a thermochromatic material 320. The label 300, in turn, is applied to the aerosol container 100. Alternatively, the pattern can be formed directly on the container. The pattern 350 can comprise on or more shapes, such as shown in FIG. 4, or else can comprise text, symbols, or any other marking, either standing alone or hidden within other graphics. The background of the label (or container surface) may also include a thermochromatic material, in which case the background constitutes a part of the thermochromatic pattern.

The decorative pattern can appear or disappear, wholly or in part, as the temperature of the container fluctuates. If desired, the pattern can be comprised of a plurality of thermochromatic materials with varying color-play windows, so that different portions of the pattern appear at different temperatures.

### EXAMPLE

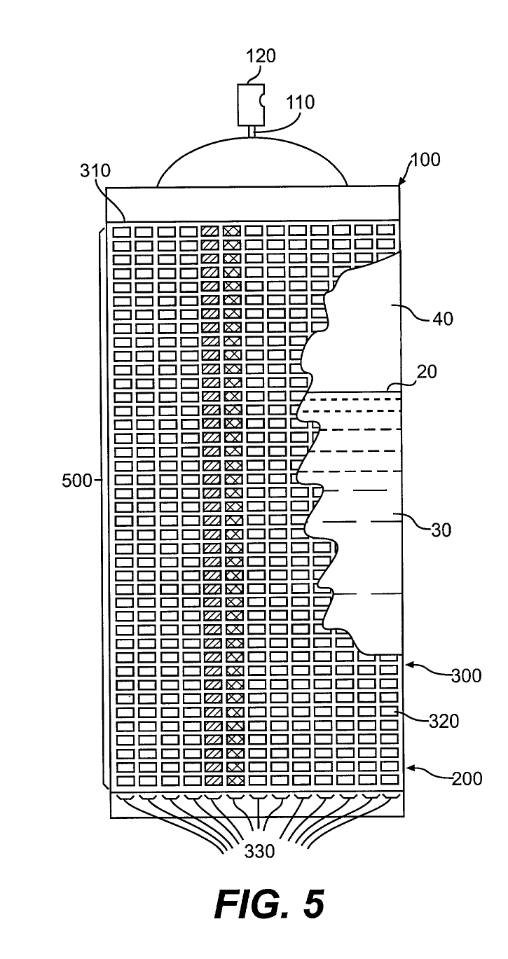

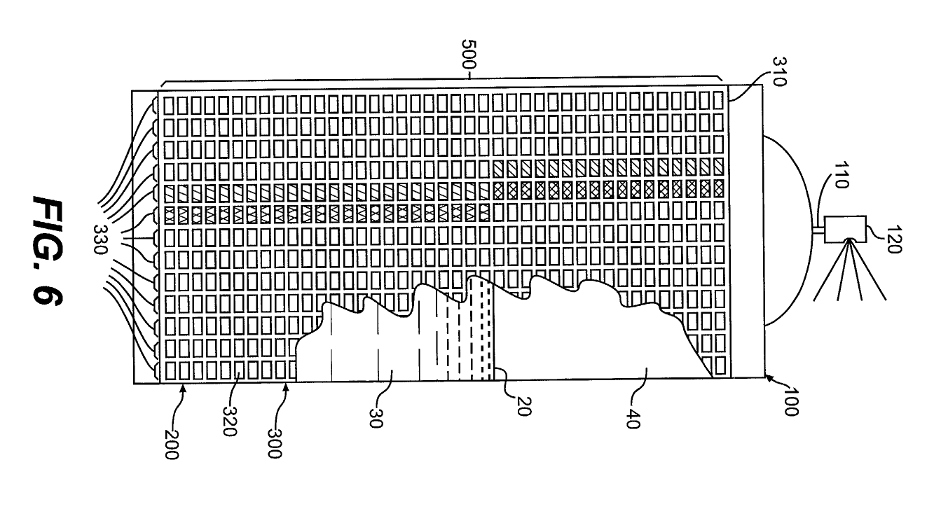

A clear plastic substrate 310 was printed with a grid 500, shown in FIGS. 5 and 6, using ordinary black ink. Thereafter, thirteen different formulations of liquid crystal compounds 320 were coated over the grid 500 in parallel vertical columns 330. The color-play windows for the thirteen liquid crystal compounds 320 were as follows:

TABLE 1
Liquid crystal compound color-play windows.

| Column | Color-Play Window |
|---|---|
| 1 | 64-66° F. |
| 2 | 66-68° F. |
| 3 | 68-70° F. |
| 4 | 70-72° F. |
| 5 | 72-74° F. |
| 6 | 74-76° F. |
| 7 | 76-78° F. |
| 8 | 78-80° F. |
| 9 | 80-82° F. |
| 10 | 82-84° F. |
| 11 | 84-86° F. |
| 12 | 86-88° F. |
| 13 | 88-90° F. |

Next, a layer of ordinary black ink (not shown) was coated over the liquid crystal compounds 320. Thereafter, a pressure sensitive adhesive (not shown) was applied to the layer of black ink to form a label 300. The label 300 was adhesively secured to a nine ounce aerosol canister 100 containing an air freshener product 10 comprising a fragrance, a water intermediate, and a propellant. The canister 100 was constructed of tin plate steel, with a wall thickness of about 0.01 inches.

The temperature of the canister 100, sitting at rest, was uniformly measured at about 74° F. in the thermochromatic indicator 200. Accordingly, each column 330 of thermochromatic material 320 appeared continuous in color, as shown in FIG. 5.

The air freshener product 10 then was dispensed from the canister 100 for five seconds. Afterwards, the lower portion of the canister wall was measured at about 74° F., while the upper portion of the canister wall was measured at about 70-72° F. The temperature of the canister wall changed abruptly at the interface of the filled volume 30 (i.e., liquid portion) and the empty volume 40 (i.e., gaseous headspace). As shown in FIG. 6, several of the columns 330 of thermochromatic material 320 abruptly changed in color at the fill level 20 of the canister 100, thereby providing a visual indication of the fill level 20.

The embodiments discussed above are representative of embodiments of the present invention and are provided for illustrative purposes only. They are not intended to limit the scope of the invention. Although specific structures, materials, temperatures, etc., have been shown and described, such are not limiting. Modifications and variations are contemplated within the scope of the present invention, which is intended to be limited only by the scope of the accompanying claims.

### INDUSTRIAL APPLICABILITY

This present invention relates to a thermochromatic indicator for an aerosol container. The thermochromatic indicator can provide a visual indication of at least one of (i) a fill level of flowable product in the aerosol container and (ii) whether the temperature of the aerosol container in the vicinity of the thermochromatic indicator exceeds a predetermined temperature. The present invention will help users of aerosol products know how much product is left in the container and will warn users if the temperature of the aerosol container reaches an unsafe level.

We claim:

1. An aerosol container, comprising:
an aerosol canister for containing a flowable product at a pressure greater than ambient pressure;
a dispensing valve for dispensing the flowable product from the aerosol canister; and
a thermochromatic indicator provided on the aerosol canister for providing a visual indication of a state of the aerosol container.

2. The aerosol container of claim 1, wherein the thermochromatic indicator provides a visual indication of a fill level of the flowable product in the aerosol canister.

3. The aerosol container of claim 2, wherein the thermochromatic indicator comprises at least one column of a thermochromatic material.

4. The aerosol container of claim 2, wherein the thermochromatic indicator comprises a plurality of columns of a plurality of thermochromatic materials, and each column is comprised of a thermochromatic material having a color-play window that is different than the color-play windows of the thermochromatic materials of adjacent columns.

5. The aerosol container of claim 4, wherein each thermochromatic material is at least one of a liquid crystal compound and a leuco dye.

6. The aerosol container of claim 2, further comprising a time-to-replace indicator in association with the thermochromatic indicator.

7. The aerosol container of claim 1, wherein the thermochromatic indicator provides a visual warning if the temperature of the aerosol canister in the vicinity of the thermochromatic indicator exceeds a predetermined temperature.

8. The aerosol container of claim 1, wherein the thermochromatic indicator comprises a label including at least one thermochromatic material.

9. The aerosol container of claim 1, wherein the thermochromatic indicator comprises at least one thermochromatic material printed on the aerosol canister.

10. An aerosol product, comprising:
a pressurizable aerosol container, including a dispensing valve and an actuator for selectively opening the dispensing valve;
a flowable product contained within the aerosol container; and
a thermochromatic indicator provided on the aerosol container for providing a visual indication of at least one of (i) a fill level of the flowable product in the aerosol container and (ii) whether the temperature of the aerosol container in the vicinity of the thermochromatic indicator exceeds a predetermined temperature.

11. The aerosol product of claim 10, wherein the thermochromatic indicator comprises at least one column of a thermochromatic material.

12. The aerosol product of claim 10, wherein the thermochromatic indicator comprises a plurality of columns of a plurality of thermochromatic materials, and each column is comprised of a thermochromatic material having a color-play window that is different than the color-play windows of the thermochromatic materials of adjacent columns.

13. The aerosol product of claim 12, wherein each thermochromatic material is at least one of a liquid crystal compound and a leuco dye.

14. The aerosol product of claim 10, further comprising a time-to-replace indicator in association with the thermochromatic indicator.

15. The aerosol product of claim 10, wherein the thermochromatic indicator comprises a label including at least one thermochromatic material.

16. The aerosol product of claim 10, wherein the thermochromatic indicator comprises at least one thermochromatic material printed on the aerosol container.

17. An aerosol container, comprising:
an aerosol canister for containing a flowable product at a pressure greater than ambient pressure;
means for dispensing the flowable product from the aerosol canister; and
means for providing a visual indication of at least one of (i) a fill level of the flowable product in the aerosol canister and (ii) whether the temperature of the aerosol canister exceeds a predetermined temperature.

18. The aerosol container of claim 17, wherein the visual indicating means comprises a thermochromatic indicator including at least one thermochromatic material.

19. A method of detecting a fill level of a flowable product in an aerosol container, comprising the steps of:
inducing a temperature differential in the vicinity of a thermochromatic indicator provided on a wall of the aerosol container; and
detecting, based on a change in appearance of the thermochromatic indicator, the fill level of the flowable product in the aerosol container.

20. The method of claim 19, wherein the inducing step comprises a step of exposing the aerosol container to heat from an external source.

21. The method of claim 19, wherein the inducing step comprises a step of artificially cooling the aerosol container.

22. The method of claim 19, wherein the inducing step comprises a step of dispensing the flowable product, at least in part, from the aerosol container.

23. A method of manufacturing an aerosol container having a thermochromatic indicator, comprising the steps of:
fabricating an aerosol container; and
providing a thermochromatic indicator on the aerosol container and in heat-conducting relationship to a wall of the aerosol container.

24. The method of claim 23, wherein the providing step comprises a step of printing at least one thermochromatic material on the wall of the aerosol container.

25. The method of claim 23, wherein the providing step comprises steps of preparing a label including at least one thermochromatic material and securing the label to the wall of the aerosol container.

26. An aerosol container, comprising:
an aerosol canister for containing a flowable product at a pressure greater than ambient pressure;
a dispensing valve for dispensing the flowable product from the aerosol canister; and
an image provided on the aerosol canister, the image being formed of a thermochromatic material.

27. An aerosol container, comprising:
an aerosol canister for containing a flowable product at a pressure greater than ambient pressure;
a dispensing valve for dispensing the flowable product from the aerosol container; and
a thermochromatic pattern provided on the aerosol canister.

28. The aerosol container of claim 27, wherein the thermochromatic pattern comprises at least one of a liquid crystal compound and a leuco dye.

29. The aerosol container of claim 27, wherein the thermochromatic pattern comprises at least one of a shape, a symbol, and text.

30. The aerosol container of claim 27, wherein the thermochromatic pattern comprises a plurality of thermochromatic materials, and each thermochromatic material has a different color-play window.

31. A method of manufacturing an aerosol container having a thermochromatic pattern provided thereon, comprising the steps of:
fabricating an aerosol container; and
providing a thermochromatic pattern on the aerosol container and in heat-conducting relationship to a wall of the aerosol container.
